(19) United States
(12) Patent Application Publication
(10) Pub. No.: US 2007/0278266 A1
(43) Pub. Date: Dec. 6, 2007

(54) Baton scabbard military clip

(76) Inventor: Kevin L. Parsons, Appleton, WI (US)

Correspondence Address: Welsh & Katz, Ltd.;Jon P. Christensen, 22nd Floor, 120 South Riverside Plaza, Chicago, IL, 60606, US

(21) Appl. No.: 11/240,408

(22) Filed: Sep. 30, 2005

(51) Int. Cl. A01K 97/04

(52) U.S. Cl. 224/197; 224/914

(57) ABSTRACT

A scabbard for a baton attachable to a belt of a user. The scabbard includes a receiver for the baton of the user, a resilient belt clip disposed on the receiver and a lock that releasably locks an open end of the belt clip, said lock preventing the belt from being laterally removed from the belt clip.

### FIELD OF THE INVENTION

The field of the invention relates to batons and more particularly to scabbards for carrying batons.

### BACKGROUND OF THE INVENTION

Police officers generally use some sort of scabbard for carrying batons. Such scabbards usually include a cylindrical receptacle that receives the baton and a belt attachment device for attaching the scabbard to a belt of the officer. The cylindrical receptacle may have an open bottom with a restriction that prevents the baton from sliding through the open-bottom.

The belt attachment device used by police is often provided in the form of a closed loop that has a fixed orientation with respect to the receptacle. In order to add or remove a scabbard, a police officer is required remove his belt to attach or detach the scabbard.

Baton scabbards are also used by the military (e.g., military police, peacekeepers, UN missions, etc.). Baton scabbards used by the military also have the fixed orientation between receptacle and belt attachment device. The fixed orientation makes police and military scabbards uncomfortable and difficult for a user to sit down.

In general, baton scabbards used by the military have different requirements than those used by police officers. For example, a closed loop provided on a military belt clip during manufacture would not be removable. In this regard, military style belts are provided with attachment buckles on both ends. A tab sewn onto each end of the belt prevents a buckle from being removed from a belt for installation of a closed-loop belt clip.

Because of this difficulty, military baton scabbards are provided with openable belt clips. In addition, since military personnel are often required to carry a wide variety of equipment in adverse environments, baton scabbards and belt clips are usually fabricated of very thin sheet metal. The sheet metal of the belt clip may be formed into a pair of hinged metal plates that enclose the military belt. A set of locking springs may be used in a capture arrangement to lock the plates around the belt.

In order to allow for easy removal of military scabbards, the locking springs are relatively large and protrude in an awkward manner from the belt clip of the scabbard. The protruding springs often snag or damage other equipment. In addition, while the metallic belt clips of military scabbards are useful for the military environment, they are subject to environmental deterioration (i.e., they rust). Accordingly, a need exists for a scabbard that is better adapted to the military environment.

### SUMMARY

A scabbard for a baton is provided that is attachable to a belt of a user. The scabbard includes a receiver for the baton of the user, a resilient belt clip disposed on the receiver and a lock that releasably locks an open end of the belt clip. The lock prevents the belt from being laterally removed from the belt clip.

The resilient belt clip may be adapted for use with a military style belt. An adapter may be provided that allows use of the scabbard with U.S. style and with European style military belts.

The resilient belt clip may include a belt attachment plate rotatably secured to the receiver. The resilient belt clip includes a flat clip rigidly attached on a first end to a first end of the belt attachment plate. The lock releasably locks a second end of the flat clip to a second end of the belt attachment plate, said belt attachment surface and belt clip defining a belt passageway therebetween.

A detent disposed on the flat clip may engage an aperture in the belt attachment plate to releasably lock the second end of the flat clip to the belt attachment plate. The detent includes a pair of spring-loaded catches. A pair of locking arms supporting the spring-loaded catches may extend from the second end of the flat clip to engage a pair of lock apertures, said lock being configured so that the catches of the belt clip can be disengaged from the apertures of the belt attachment plate by squeezing the pair of locking arms together between a thumb and forefinger of the user.

A center peg may extend from the second end of the flat clip between the pair of locking arms. The center peg may be configured to engage a peg aperture located in the belt attachment plate between the pair of locking apertures to resist lateral movement between the flat clip and belt attachment plate.

A stress distribution structure may be disposed on the first end of the belt attachment plate and a complementary stress distribution structure may be disposed on the first end of the flat clip. The stress distribution structures are adapted to distribute mechanical stresses from the flat clip to the belt attachment plate. The stress distribution structures may include a plug and socket arrangement. A screw may secure the plug to the socket.

The belt attachment plate and flat clip may include a complementary set of apertures adapted to allow a connecting member to lock the belt attachment plate to the flat clip to prevent rotation. The belt attachment plate may also include a disassembly tool disposed within a receptacle within the belt attachment plate on a side of the belt attachment plate that faces the receiver.

### BRIEF DESCRIPTION OF THE DRAWINGS

FIG. 1 shows a scabbard under an illustrated embodiment of the invention;

FIG. 2a-c shows front, side and end views of the belt attachment plate shown in FIG. 1; and

FIGS. 3a-c shows front, side and end views of the flat clip shown in FIG. 1.

### DETAILED DESCRIPTION OF AN ILLUSTRATED EMBODIMENT

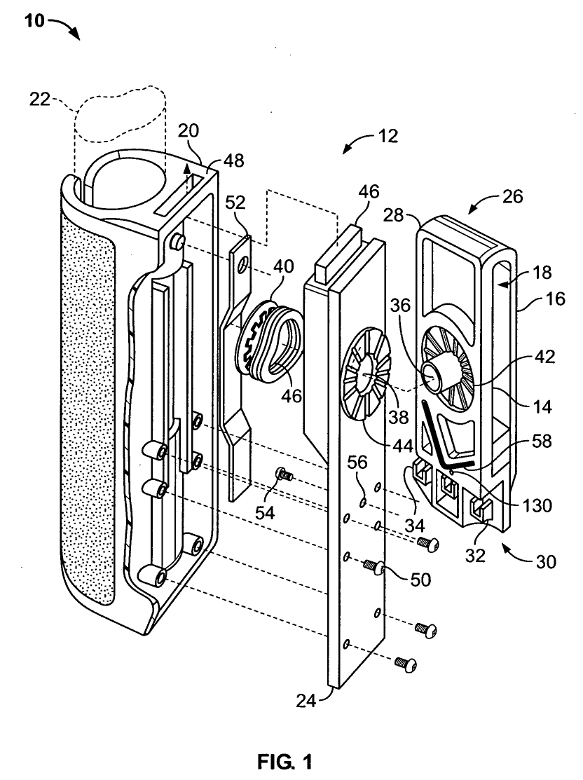

FIG. 1 is an exploded, side perspective view of a military scabbard 10 shown generally in accordance with an illustrated embodiment of the invention. In general, the scabbard 10 includes a baton receiver 12 and a U-shaped belt clip 26. The belt clip 26 includes a lock 30 that closes off an open end of the U-shaped belt clip 26.

The belt clip 26 may include a belt attachment plate 28 and a flat clip 16. An inner surface (belt attachment surface) 14 of the belt attachment plate 28 and an inner surface of the resilient flat clip 16 together define a belt passageway 18 for a military belt (not shown) that may be passed through the clip 26 of the scabbard 10.

The lock 30 positively locks the flat clip 16 to the belt attachment plate 28 to prevent accidental disengagement of the scabbard 10 from the belt of the user. Locking in this case means that the scabbard 10 cannot be removed from the belt of the user without the user intentionally releasing the lock (locking mechanism) 30 that locks one end of the clip 16 to a corresponding end of the belt attachment plate 28.

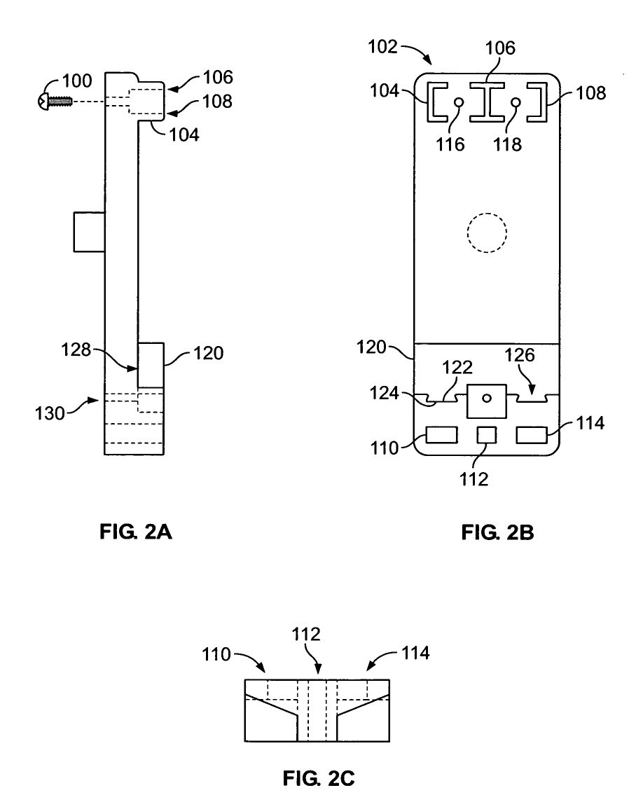

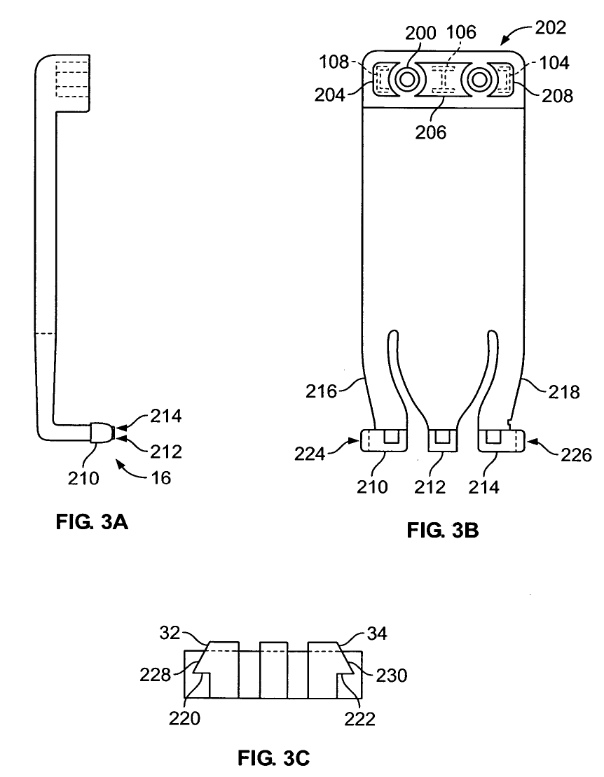

FIGS. 2a-c shows top, side and end views of the belt attachment plate 28 of the belt clip 26. FIGS. 3a-c shows top, side and end views of the flat clip 16 of the belt clip 26. Reference shall be made to FIGS. 2a-c and 3a-c as necessary to an understanding of the invention.

In general, the flat clip 16 and attachment plate 28 form a closed loop around the belt passageway 18 that can only be unlocked and opened at a second end adjacent the lock 30. The other end of the belt passageway 18 may be closed by rigidly joining a first end of the attachment plate 28 to a first end of the flat clip 16.

The respective first ends of the attachment plate 28 and clip 16 may be joined via a set of mechanical attachment devices (e.g., screws 100 and metal inserts or bosses 200) and stress distribution structures (e.g., plugs 102 and sockets 202).

The attachment plate 28 and flat clip 16 may be formed of a resilient material (e.g., plastic). The metal inserts or bosses 200 may be molded into the flat clip 16.

The stress distribution structures 102 and 202 function to absorb and distribute lateral and torsional forces. As such, the forces on the mechanical attachment devices 100, 200 are predominantly axial.

The plugs 102 of the stress distribution structures may be formed of a number of raised rib structures 104, 106, 108 that surround a set of screw holes 116, 118. The flat clip 16 may include a complementary set of sockets 204, 206, 208 adapted to receive the plugs 102, 104, 106 (as shown in phantom in FIG. 2b). The stress distribution structures 102, 202 may be provided with a tapered fit (e.g., 1-2%) along an axis of engagement. Since the stress distribution structures 102, 202 occupy a larger area that the screws 100 and inserts 200, the stress distribution structures 102, 202 tend to distribute the forces over a larger area and, therefore, reduce the force per unit area.

On a second, open end of the belt clip 26 (i.e., on the respective seconds ends of the attachment plate 28 and flat clip 16) is a locking mechanism 30. The locking mechanism may include a set of detents (e.g., pawls) 210, 214 (disposed on the end of resilient arms 216, 218) that releasably engage corresponding apertures 110, 114. A center peg 212 engages an aperture 112 to provide lateral stability. The outermost pawls 210, 214 may include an outwardly extending edge or catch 220, 222 that engages an outside edge of the respective aperture 110, 114 and locks the pawls 210, 214 into the aperture 110, 114.

To release the locking mechanism 30, the user must exert forces 224, 226 onto the pawls 210, 214. In the example shown, intentionally releasing the lock 30 means squeezing the outside tabs 32, 34 between the thumb and forefinger of the user to release the spring loaded catches 220, 222 and then urging the resilient flat clip 16 away from the attachment plate 28.

By urging the second end of the flat clip 16 away from the attachment plate 28, a user may open a gap between the second end of the flat clip 16 and second end of the attachment plate 28 that is large enough to laterally remove the belt from the passageway 18 (i.e. slide the belt clip 26 of the scabbard 10 onto and off the belt of the user). Once inserted onto the belt of the user, the user may re-engage the lock 30 by urging opposing outside surfaces of the respective second ends of the attachment plate 28 and flat clip 16 together until the catches 220, 222 engage the back outside edges of the apertures 110, 114. It may be noted in this regard that during engagement of the locking mechanism 30, a set of tapered edges 228, 230 force the locking pawls 210, 214 inwards until the catches 220, 222 reach and engage the rear surface of the engagement plate 28 at which time the pawls 210, 214 expand outwards thereby locking the pawls 210, 214 into the apertures 110, 114.

It should be noted that the stress distribution structure 102, 202 tend to absorb and distribute the twisting force caused by opening the second end of the belt passageway 18. In this regard, the taper of the plugs and sockets causes the plugs to bind against the sockets thereby transferring the twisting forces directly through the stress distribution structures 102, 202 rather than through the screws 100.

In another illustrated embodiment of the invention, it may be noted that European military belts tend to be wider than U.S. style military belts. In order to accommodate the narrower European military belt, a removable spacer 120 is provided.

The removable spacer 120 may be provided with a dovetail joint 126 that locks the spacer 120 within the belt passageway 18. In this regard, a dovetail 124 on the spacer 120 engages a dovetail channel 122 on a lower end of the belt passageway 18.

To remove the spacer 120, the user opens the second end of the passageway 18 as described above and removes the spacer 120 by applying a force as shown by arrow 128. To install the spacer 120, the user reverses the procedure. It should be noted in this regard that without releasing the lock 30, thereby widening the belt passageway 18, the spacer 120 cannot be removed.

It should be noted that the belt clip 26 may be effectively combined with any kind of receiver 12. The receiver 12 may include a baton holder 20 and back cover 24. The baton holder 20 may have a substantially cylindrical interior wall that defines an interior chamber or passage within which the baton may be placed.

The baton holder 20 may be attached to the belt clip 26 via the back cover 24. The belt clip 26 may be attached to the back cover 24 by inserting a post 36 through an opening 38 in the back cover 24 and securing the belt clip 26 to the back cover via a fastener 40.

The baton holder 20 and back cover 24 may be rotated with respect to the belt clip 26. An orientation of the baton holder 20 with respect to the belt clip 26 may be secured by a number of teeth 42 (e.g., 12) extending radially outwards from a hub of the post 26 and a complementary set of radially extending grooves 44 on the back cover 24. The teeth 42 may be urged into contact with the grooves 44 via a set of wave washers 46 operating against the fastener 40 and post 36. The set of 12 teeth and grooves may provide the opportunity to select one of up to twelve different positions (angles) of the baton with respect to the belt of the user. The twelve different positions allow the belt clip 26 to be inserted over the top of the user's belt or from the bottom.

The back cover 24 may be secured to the baton holder 20 on a first end via a tab 46 that engages a slot 48 within the baton holder 20. A set of screws 50 may be used to secure a second end of the back cover 24 to the baton holder 20.

A spring 52 may extend through a window in the side wall of the baton holder 20 to secure the baton 22 within the baton holder 20. The spring 52 may be held in place via direct contact with the back cover 24.

The back cover 24 and belt clip 26 are all of the same width and are, therefore, flush with the edges of the baton holder 20, so as not to interfere with other equipment supported on the belt of the user. The tabs 32, 34 for releasing the lock mechanism 30 are recessed into a body of the attachment plate 28 to prevent accidental release of the locking mechanism 30.

Under certain conditions, it may be useful to secure the belt clip 26 to the back cover 24 to prevent unintentional rotation of the baton holder 20 with respect to the belt clip 26. To prevent rotation, a screw 54 may be inserted through an aperture 56 in the back cover 24 to engage a threaded aperture 130 in the belt attachment plate 28.

The scabbard 10 has a rugged design that is resistant to wear or failure. However, in the unlikely event that the flat clip 16 should become broken, the flat clip 16 is easily replaceable. In this case, the user may simply remove the screws 100, remove the broken clip 16 and replace the clip 16 with a new clip 16.

In order to facilitate easy disassembly of the scabbard 10 (or replacement of the clip 16), a hex key 58 is provided within a recess on the backside of the belt attachment plate 28. In this case, the user may simply rotate the belt attachment plate 28 to a 90 degree position with respect to the back cover 24 to expose the hex key 56. The hex key 56 may then be removed from its recess and repairs made to the scabbard 10 without further equipment.

A specific embodiment of a scabbard for a baton has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A scabbard for a baton attachable to a belt of a user, such scabbard comprising:
a receiver that holds the baton of the user;
a resilient belt clip disposed on the receiver; and
a lock that releasably locks an open end of the belt clip, said lock preventing the belt from being laterally removed from the belt clip while in a locked state.

2. The scabbard for a baton as in claim 1 wherein the resilient belt clip is adapted for use with a military belt.

3. The scabbard for a baton as in claim 1 wherein the resilient belt clip further comprises a belt attachment plate rotatably secured to the receiver.

4. The scabbard for a baton as in claim 3 wherein the resilient belt clip further comprises a flat clip rigidly attached on a first end to a first end of the belt attachment plate.

5. The scabbard for a baton as in claim 4 wherein the lock releasably locks a second end of the flat clip to a second end of the belt attachment plate, said belt attachment surface and belt clip defining a belt passageway therebetween

6. The baton scabbard as in claim 5 wherein the lock mechanism further comprises a detent disposed on the flat clip that engages an aperture in the belt attachment plate to releasably lock the second end of the flat clip to the belt attachment plate.

7. The baton scabbard as in claim 6 wherein the detent further comprises a pair of spring-loaded catches.

8. The baton scabbard as in claim 7 wherein the detent further comprises a pair of locking arms supporting the spring-loaded catches extending from the second end of the flat clip to engage a pair of lock apertures, said lock being configured so that the catches of the belt clip can be disengaged from the apertures of the belt attachment plate by squeezing the pair of locking arms together between a thumb and forefinger of the user.

9. The baton scabbard as in claim 8 further comprising a center peg extending from the second end of the flat clip between the pair of locking arms, said center peg being configured to engage a peg aperture located in the belt attachment plate between the pair of locking apertures to resist lateral movement between the flat clip and belt attachment plate.

10. The baton scabbard as in claim 1 further comprising a stress distribution structure disposed on the first end of the belt attachment plate and a complementary stress distribution structure disposed on the first end of the flat clip, the stress distribution structures being adapted to distribute mechanical stresses from the flat clip to the belt attachment plate.

11. The baton scabbard as in claim 10 wherein the stress distribution structures further comprise a plug and socket arrangement.

12. The baton scabbard as in claim 11 further comprising a screw that secures the plug to the socket.

13. The baton scabbard as in claim 1 wherein the belt attachment plate and flat clip further comprise a complementary set of apertures adapted to allow a connecting member to lock the belt attachment plate to the flat clip to prevent rotation.

14. The baton scabbard as in claim 13 wherein the belt attachment plate further comprises a disassembly tool disposed within a receptacle within the belt attachment plate on a side of the belt attachment plate that faces the receiver.

15. The baton scabbard as in claim 1 further comprising a spacer removeably disposed between the belt attachment plate and flat clip and adapted to allow the use of the scabbard with a European-style military belt.

16. A scabbard for a baton attachable to a belt of a user, such scabbard comprising:
a receiver for the baton of the user;
a belt attachment surface disposed on the receiver;
a resilient flat clip rigidly attached on a first end to a first end of the belt attachment surface; and
a locking mechanism that releasably locks a second end of the flat clip to a second end of the belt attachment surface, said belt attachment surface and flat clip defining a belt passageway therebetween.

17. The baton scabbard as in claim 16 wherein the locking mechanism further comprises a detent disposed on the flat clip that engages an aperture in the belt attachment surface to releasably lock the second end of the flat clip to the belt attachment surface.

18. The baton scabbard as in claim 17 wherein the detent further comprises a pair of spring-loaded catches.

19. The baton scabbard as in claim 18 wherein the detent further comprises a pair of locking arms supporting the spring-loaded catches extending from the second end of the flat clip to engage a pair of lock apertures, said locking mechanism being configured so that the catches of the flat clip can be disengaged from the apertures of the belt attachment surface by squeezing the pair of locking arms together between a thumb and forefinger of the user.

20. The baton scabbard as in claim 19 further comprising a center peg extending from the second end of the flat clip between the pair of locking arms, said center peg being configured to engage a peg aperture located in the belt attachment surface between the pair of locking apertures to resist lateral movement between the flat clip and belt attachment surface.

21. The baton scabbard as in claim 16 further comprising a stress distribution structure disposed on the first end of the belt attachment surface and a complementary stress distribution structure disposed on the first end of the flat clip, the stress distribution structures being adapted to distribute mechanical stresses from the flat clip to the belt attachment surface.

22. The baton scabbard as in claim 21 wherein the stress distribution structures further comprise a plug and socket arrangement.

23. The baton scabbard as in claim 22 further comprising a screw that secures the plug to the socket.

24. The baton scabbard as in claim 16 wherein the belt attachment surface and flat clip further comprise a complementary set of apertures adapted to allow a connecting member to lock the belt attachment surface to the flat clip to prevent rotation.

25. The baton scabbard as in claim 24 wherein the belt attachment surface further comprises a belt attachment plate with a disassembly tool disposed within a receptacle within the belt attachment plate on a side of the belt attachment plate that faces the receiver.

26. The baton scabbard as in claim 16 further comprising a spacer removeably disposed between the belt attachment surface and adapted to allow the use of the scabbard with a European-style military belt.

27. A scabbard for a baton attachable to a belt of a user, such scabbard comprising:
a baton holder that receives the baton of the user;
a back cover secured to the baton holder;
a belt attachment plate rotatably secured to the back plate;
a resilient flat clip rigidly attached on a first end to a belt attachment surface on a first end of the belt attachment plate; and
a locking mechanism that releasably locks a second end of the belt clip to a second end of the belt attachment surface, said belt attachment surface and flat clip together defining a belt passageway therebetween.

28. The baton scabbard as in claim 27 wherein the locking mechanism further comprises a detent disposed on the flat clip that engages an aperture in the belt attachment surface to releasably lock the second end of the flat clip to the belt attachment surface.

29. The baton scabbard as in claim 28 wherein the detent further comprises a pair of spring-loaded catches.

30. The baton scabbard as in claim 29 wherein the detent further comprises a pair of locking arms supporting the spring-loaded catches extending from the second end of the flat clip to engage a pair of lock apertures, said locking mechanism being configured so that the catches of the belt clip can be disengaged from the apertures of the belt attachment surface by squeezing the pair of locking arms together between a thumb and forefinger of the user.

31. The baton scabbard as in claim 30 further comprising a center peg extending from the second end of the flat clip between the pair of locking arms, said center peg being configured to engage a peg aperture located in the belt attachment surface between the pair of locking apertures to resist lateral movement between the flat clip and belt attachment surface.

32. The baton scabbard as in claim 27 further comprising a stress distribution structure disposed on the first end of the belt attachment surface and a complementary stress distribution structure disposed on the first end of the belt clip, the stress distribution structures being adapted to distribute mechanical stresses from the flat clip to the belt attachment plate.

33. The baton scabbard as in claim 32 wherein the stress distribution structures further comprise a plug and socket arrangement.

34. The baton scabbard as in claim 33 further comprising a screw that secures the plug to the socket.

35. The baton scabbard as in claim 27 wherein the belt attachment surface and flat clip further including a complementary set of apertures adapted to allow a connecting member to lock the belt attachment plate to the flat clip to prevent rotation.

36. The baton scabbard as in claim 35 wherein the belt attachment plate further comprises a disassembly tool disposed within a receptacle within the belt attachment plate on a side of the belt attachment plate that faces the baton holder.

37. A scabbard for a baton attachable to a belt of a user, such scabbard comprising:
a receiver that holds the baton of the user;
a belt clip, said belt clip further comprising:
a belt attachment surface attached to the receiver; and
a resilient clip removably attached on a first end to a first end of the belt attachment surface, said resilient clip and the belt attachment surface together forming a belt attachment slot therebetween that is openable on a second end to accept a belt into the belt attachment slot.

38. A scabbard for a baton attachable to a belt of a user, such scabbard comprising:
a receiver that holds the baton of the user;
a belt clip, said belt clip further comprising:
a belt attachment surface attached to the receiver;
a resilient clip attached on a first end to a first end of the belt attachment surface, said resilient clip and belt attachment surface together forming a belt attachment slot therebetween that is openable on a second end; and
a belt spacer removably disposed within the slot, said belt spacer being disposed within the slot so as to accept a relative narrow belt and removed to accept a relatively wide belt.

39. The scabbard to the baton as in claim 38 further comprising a dovetail on the belt spacer and complementary dovetail on the belt attachment surface, said dovetail and complementary dovetail being oriented so that the belt spacer can only be removed when the belt slot is opened on the second end.
